(19) United States
(12) Patent Application Publication
(10) Pub. No.: US 2010/0300081 A1
(43) Pub. Date: Dec. 2, 2010

(54) FLASH HEAT AMMONIA GENERATOR

(76) Inventors: Gary C. Fulks, Rochester, MI (US); Kenneth M. Rahmoeller, West Bloomfield, MI (US)

Correspondence Address: DELPHI TECHNOLOGIES, INC, M/C 480-410-202, PO BOX 5052, TROY, MI, 48007, US

(21) Appl. No.: 12/637,371

(22) Filed: Dec. 14, 2009

Related U.S. Application Data
(60) Provisional application No. 61/182,968, filed on Jun. 1, 2009.

(51) Int. Cl. F01N 3/10; C01C 1/00; C01C 1/02; B01J 19/00

(52) U.S. Cl. 60/299; 423/352; 423/356; 422/148; 60/303

(57) ABSTRACT

An ammonia producing device for an exhaust system of an engine is provided. It includes a pressure vessel having a cavity for storage of pressurized gases. The pressure vessel includes insulation located at least partially about the cavity for limiting heat transfer from within the cavity. A flash heater is disposed within the cavity and adjacent a solid ammonia gas producing material. An outlet port extends from the pressure vessel and has a valve located therein for providing egress of pressurized gases from within the pressure vessel.

### CROSS REFERENCE TO RELATED APPLICATIONS

This application claims priority to U.S. Provisional Application No. 61/182,968, filed Jun. 1, 2009, the contents of which are incorporated by reference herein.

### BACKGROUND OF THE INVENTION

Exhaust emission control has been and will continue to be of interest as effects of emissions from stationary and transient emission generating devices are continually being understood. This, along with government mandates, have caused manufacturers of emission generating devices, particularly internal combustion engines, to develop methods and devices for controlling the content of emissions emanating from such devices. In one particular sector, due to the advantages of diesel burning engines over gasoline burning engines, advancements of emission control for diesel engines are continuingly being sought. These advancements include emission control devices configured for removing particulate matter from an exhaust gas stream and Selective Catalyst Reduction (SCR) technology that converts certain exhaust gases, such as NOₓ to specific exhaust gas outputs such as nitrogen and water.

One particular advancement in the reduction of emissions from diesel and gasoline burning engines is the application of a urea solution to an exhaust gas stream prior to treatment by one or more components of an SCR treatment system. Specifically, current SCR systems employ a 32% aqueous solution of urea which is injected in liquid form into the exhaust ahead of the SCR catalyst where it is hydrolyzed and ultimately thermo-hydrolyzed into NH3 and CO2. The addition of ammonia and/or urea solution improves efficiency of the conversion of the NOₓ.

Increased effectiveness of the ammonia or urea is achieved at higher temperatures. During certain operating conditions, such as extreme cold temperatures, the ammonia or urea solution may become frozen, particularly below the freezing temperature of urea solution, e.g., −12° C., thereby losing the ability to inject the solution into the exhaust gas stream. In order to maintain effectiveness of the urea injection system, the use of heating systems for thawing the urea solution have been employed. The use of cool urea solution leads to the development of crystallized urea on the urea injector, exhaust components or exhaust treatment device, also reducing the efficiency of the urea injection system.

In addition, the use of aqueous urea solution contains a relatively low quantity of NH3 on a volume basis especially when compared with a solid ammonia transport material such as urea, ammonium carbamate and ammonium carbonate. As such, in order to maintain efficiency over long periods of time, a significant urea solution must be contained on board a vehicle. This adds both weight and cost to the vehicle.

In view of the foregoing, there is a need for improved delivery systems capable of providing ammonia to an exhaust treatment device, such as a SCR device, that minimizes power consumption and storage requirements.

### SUMMARY OF THE INVENTION

An ammonia producing device for an exhaust system of an engine is provided. It includes a pressure vessel having a cavity for storage of pressurized gases. The pressure vessel includes insulation located at least partially about the cavity for limiting heat transfer from within the cavity. A flash heater is disposed within the cavity and adjacent a solid ammonia gas producing material. An outlet port extends from the pressure vessel and has a valve located therein for providing egress of pressurized gases from within the pressure vessel.

In another embodiment, an exhaust system of an engine is provided. It includes a pressure vessel including a flash heater and a solid ammonia gas producing material disposed therein. The solid ammonia gas producing material is in contact with the flash heater. It generates a heat suitable for decomposition of the solid ammonia gas producing material. A manifold having an ammonia gas inlet is in fluid communication with the pressure vessel and has an exhaust gas inlet and an exhaust gas outlet in fluid communication with a main exhaust supply line. A control valve regulates the flow of ammonia gas between the pressure vessel and the manifold. A controller is in communication with the flash heater and the control valve, the controller causes actuation of the flash heater upon a pressure drop signal from within the pressure vessel and causes opening of the control valve to allow stored ammonia gas to enter the manifold and the exhaust gas stream.

In yet another embodiment, a method of generating ammonia gas for use by a selective catalytic reduction device is provided. It comprises fluidly coupling a cavity of a pressure vessel to an exhaust gas stream of an engine and providing a flash heater and a solid ammonia gas producing material within the cavity of the pressure vessel. Heating of the flash heater to a temperature suitable for causing decomposition of the solid ammonia gas producing material generates an ammonia gas. The ammonia gas is stored within the pressure vessel between successive heating cycles of the flash heater and is provided to the exhaust gas stream upon the initiation of a new heating cycle.

These and other advantages and features will become more apparent from the following description taken in conjunction with the drawings.

### BRIEF DESCRIPTION OF THE DRAWINGS

The subject matter which is regarded as the invention is particularly pointed out and distinctly claimed in the claims at the conclusion of the specification. The foregoing and other features, and advantages of the invention are apparent from the following detailed description taken in conjunction with the accompanying drawings in which:

FIG. 1 is a perspective view, in cross-section, of an ammonia producing device in accordance with the present invention;

FIG. 2 is a top view of the ammonia producing device in accordance with the present invention;

FIG. 3 is an elevation view of the ammonia producing device in accordance with the present invention;

FIG. 4 is a first side elevation view of the ammonia producing device in accordance with the present invention;

FIG. 5 is a second side elevation view of the ammonia producing device in accordance with the present invention;

FIG. 6 is a top view of the flash heater;

FIG. 7 is a functional flow diagram showing another aspect of the present invention;

FIG. 8 is functional diagram showing the ammonia producing device in accordance with the present invention;

FIG. 9 is a graphical illustration showing an aspect of the present invention; and

FIG. 10 is a graphical illustration showing another aspect of the present invention.

### DETAILED DESCRIPTION

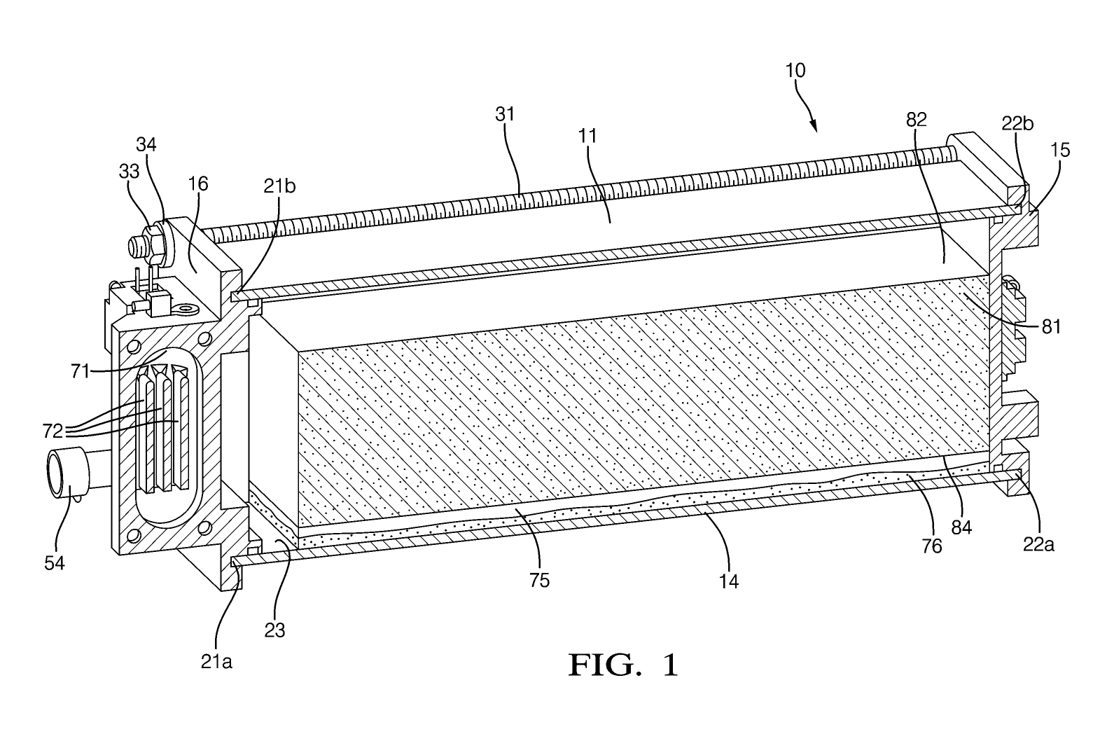

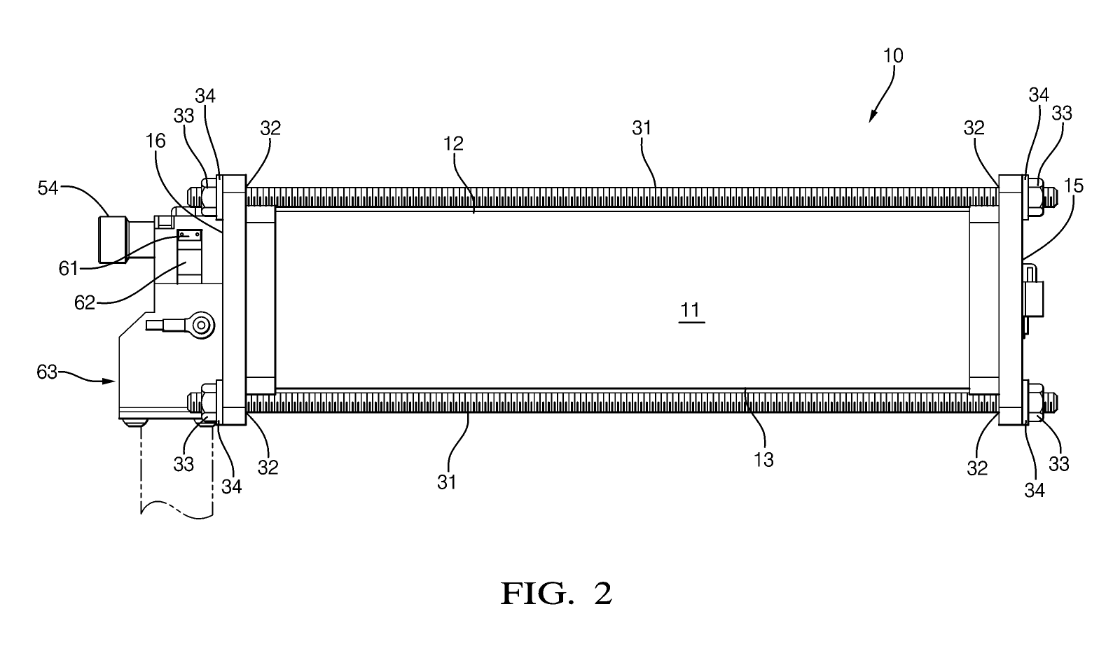

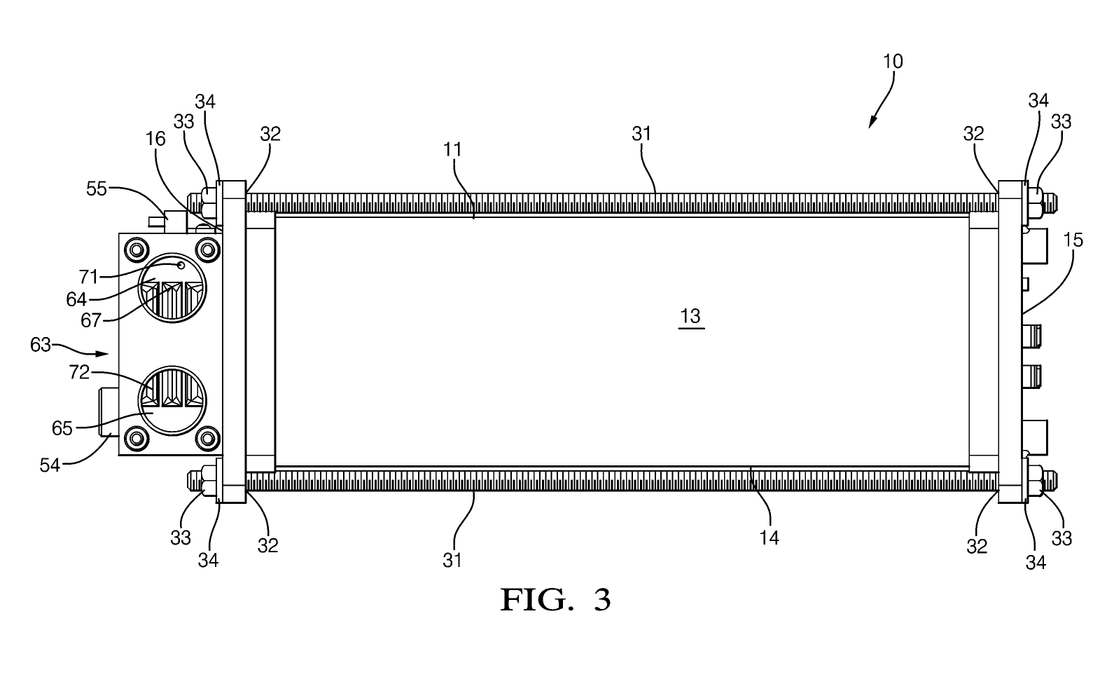

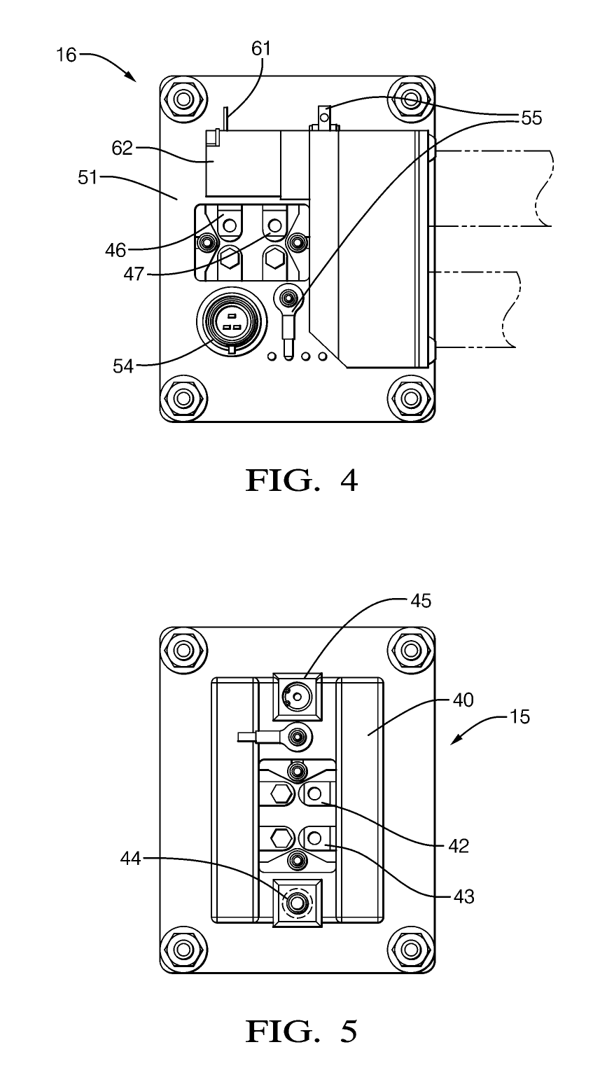

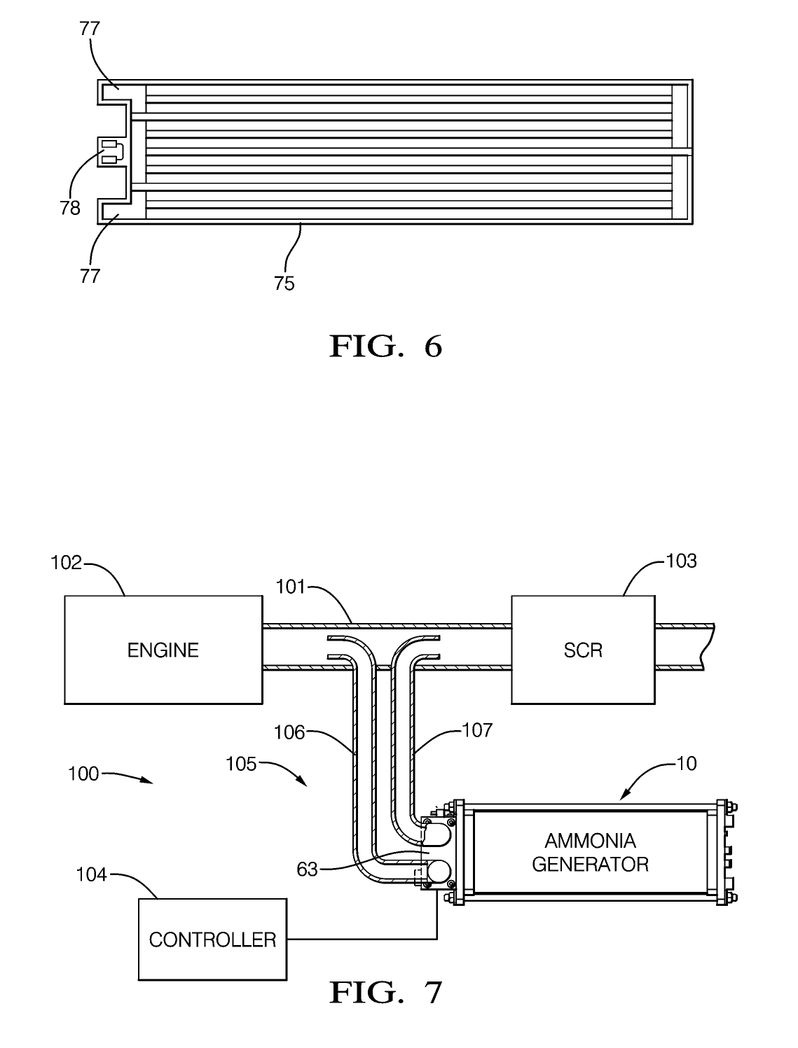

Referring now to the Figures and the Appendix (the entirety of which is incorporated by reference herein), where the invention will be described with reference to specific embodiments, without limiting same, a cross section through an ammonia generator pressure vessel reactor 10 is shown in FIGS. 1, 2 and 3. Additional details are shown in the Appendix. The ammonia generator is comprised of side walls 11, 12, 13 and 14, with end walls 15 and 16 to form a rectangular configuration.

As shown in FIG. 1, side walls 11, 12, 13, and 14 fit into notches 21 and 22 located within end walls 15 and 16 to form a cavity 23 within ammonia generator 10. End walls 11, 12, 13 and 14 are retained within notches 21 by threaded screw stock 31 that spans the length of ammonia generator 10 and is retained in opposing end walls 15 and 16 by extending through holes 32 and retained in compression by nuts 33 and washers 34. In this way, a pressure vessel 10 having a rectangular cross-section is created for purposes that will be described later. It will be appreciated that there are numerous ways to create a pressure vessel 10, and the aforementioned is intended only as a non-limiting exemplary embodiment.

End wall 15 includes a pressure relief valve 45 which extends through the end wall 15 from the exterior side 40 to the interior and cavity 23. Two heaters 42 and 43 are located on the exterior side 40 of end wall 15 for the purpose of heating cavity 23 of pressure vessel 10. In the embodiment shown, heaters 42 and 43 are 200 W resistors that act as heaters. Obviously other heater types may be used for the purposes described herein. End wall 15 also includes an NPT plug 44 extending therethrough.

End wall 16 includes a pressure transducer 54 for the purpose of measuring and maintaining pressure within cavity 23. Pressure sensor 54 extends from the exterior side 51, through end wall 16, to the interior and cavity 23. In an exemplary embodiment, pressure within cavity 23 is maintained at about 5 psi to 40 psi and more particularly at about 25 psi when in a working mode. Obviously, the dynamic characteristics of the reactor, as will be described hereinafter, can cause the pressure to vary significantly. Two additional heaters 46 and 47 are located on the exterior side 51 of end wall 16 for the purpose of heating cavity 23 of pressure vessel 10. Like heaters 42 and 43, heaters 46 and 47 are 200 W resistors that act as heaters. Other types of heaters could be substituted for the resistor heaters shown. A thermistor and temperature sensor 55 is located on end wall 16 for determining and maintaining a working temperature within pressure vessel 10. In an exemplary embodiment, the working temperature is of cavity 23 is maintained at about 60 to about 100 degrees C. and more particularly at about 70 degrees C.

A normally closed solenoid valve 61 is in fluid communication with cavity 23 of pressure vessel 10 through an orifice within solenoid retainer 62. A manifold 63 is in fluid communication with cavity 23 through solenoid valve 61. As shown, manifold 63 has an exhaust gas inlet 64 and an exhaust gas outlet 65. Located between inlet 64 and outlet 65 is a plenum chamber 67 through which exhaust gas passes and is mixed with pressurized ammonia injected from cavity 23 through solenoid valve 61. Adjacent inlet 64 is an ammonia inlet 71 through which ammonia gas is injected into plenum chamber 67. The flow of exhaust through the plenum chamber 67 aids mixing & provides a continuous transport media preventing re-composition of solid ammonium carbamate. Advantageous flow of heat from the exhaust to the reactor is assisted by multiple vanes 72 thus reducing energy required to decompose & improving decomposition efficiency.

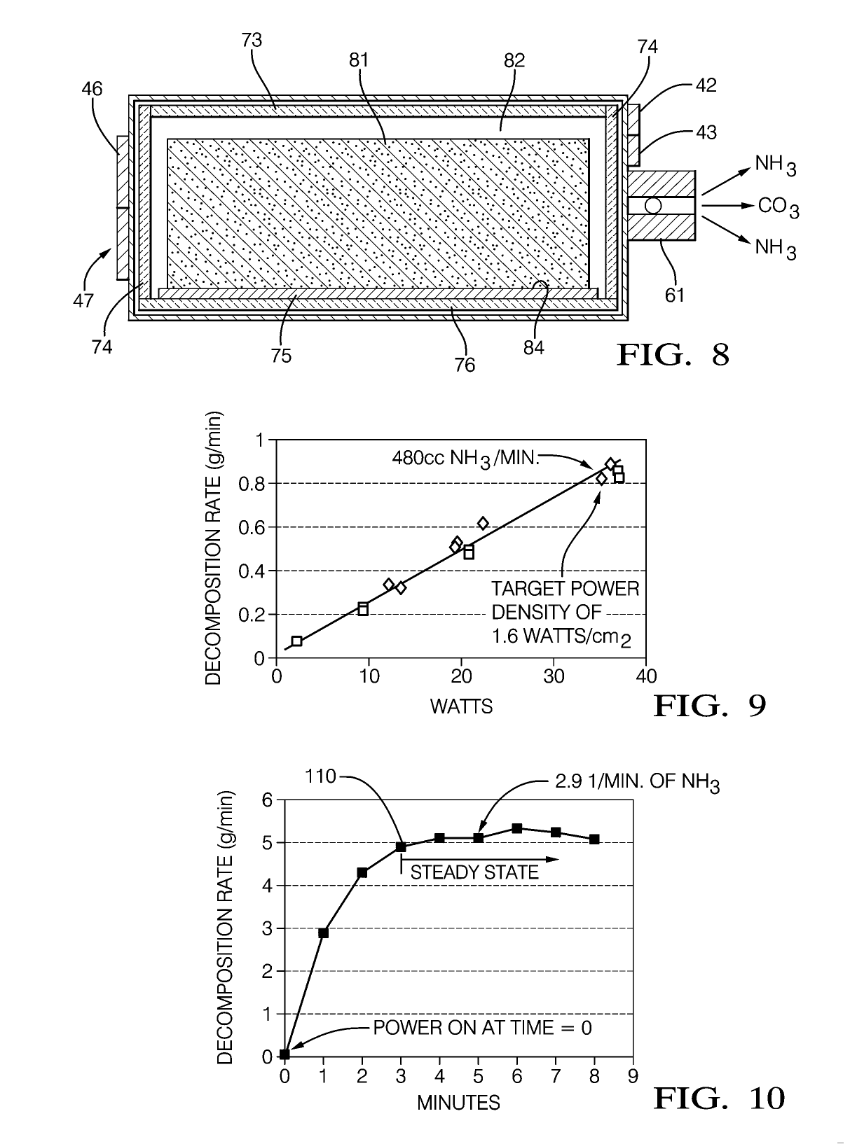

As best seen in FIG. 8, pressure cavity insulation 73 is disposed on the interior side of walls 11, 12, 13 and 14, while end wall insulation 74 is disposed on the interior side of end walls 15 and 16. Teflon is a preferred insulating material as in addition to limiting heat loss, it prevents recomposed ammonium carbamate from attaching to the interior walls. Insulation 73 and 74 keep heat within cavity 23, as discussed above at about 60 degrees C. to about 100 degrees C., for purpose described herein. Alternatively, insulation 73 and 74 may be disposed about the entirety of the interior of pressure vessel 10, in selected locations throughout the interior of pressure vessel 10, along the exterior of pressure vessel 10 or any number of subcombinations that efficiently achieve the target temperature ranges. A flash heater 75 is located within cavity 23 and is disposed adjacent a flash heater insulation layer 76 that is disposed between end wall 14 and flash heater 75. In the embodiment shown, flash heater insulation layer 76 is glass insulation. In the exemplary embodiment shown, flash heater 75 is a thin sheet aluminum 300 W thick film flash heater. Flash heater 75 includes electrical contact pads 77 and an NTC thermistor 78 for controlling temperature.

An ammonium carbamate block 81 is disposed within cavity 23 and adjacent to flash heater 75. In the embodiment shown, carbamate block 81 rests directly upon flash heater 75 so that there is face to face contact, and an interface 84 therebetween. A buffer space 82 is located about block 81 and occupies the space in cavity 23 not occupied by block 81. Block 81 is retained in the position of face to face contact with the force of gravity, and thus relies on proper orientation of pressure vessel 10 to form interface 84. While other types of methods of retaining positioning of block 81 against flash heater 75, such as springs or piston devices, each add additional weight and complexity to the system. Other types of solid ammonium salts such as ammonium carbonate may also be used. In another embodiment, ammonium carbamate block may actually be composed of multiple discrete blocks within cavity 23, instead of the single solid block shown.

The invention allows NH3 to be released from the solid form for subsequent injection into the exhaust stream 101, shown in FIG. 7, produced by engine 102. The NH3 enhanced exhaust stream is introduced into an SCR 103 for the reduction of NOX. The decomposition described herein maximizes NH3 release rate while minimizing power consumption and required storage pressure.

Ammonium salts such as ammonium carbamate and ammonium carbonate decompose into ammonia at rates that increase exponentially as a function of temperature. The equilibrium vapor pressures of these ammonium salts also increase exponentially as a function of temperature. Therefore, achieving useful NH3 production rates is complicated in that the resulting vapor pressures are generally difficult in an automotive environment, usually greater that 10 Bars. By application of multiple heat paths, the invention allows NH3 production rate to be de-coupled from the associated vapor pressure.

The generation of NH3 is directed by controller 104 and is achieved by first heating pressure vessel 10 using exterior heaters 42, 43 and 46, 47. Specifically, the cavity 23 is heated to a working temperature of about 60 degrees C. to about 100 degrees C. and is generally held to about 70 degrees C. Thereafter, power is applied to flash heater 75, sandwiched between insulation layer 76 and ammonium carbamate block 81. Insulation layer minimizes heat loss such that a very high percentage of applied electrical energy results in solid to gas decomposition.

The generation of heat from flash heater 75 results in a high temperature, generally up to about 110 degrees C. at full power, between block 81 and insulation layer 76. The temperature from flash heater 75 will cause a rapid decomposition of transport material local to interface 84 between flash heater 75 and block 81. The decomposition reaction converts ammonium carbamate NH4CO2NH2 to 2NH3+CO2 (the transport material) at interface 84. It will be appreciated that the decomposition reaction is bi-directional, but the invention contemplates preventing significant recombination of the products. The decomposition reaction causes internal pressure of cavity 23, and specifically buffer space 82, to rise at a rate far greater than that induced by the relatively low temperature induced by heaters 42, 43, 46, 47.

Controller 104 is constantly monitoring pressure sensor 54, thermistor and temperature sensor 55. When the internal pressure of buffer space 82 is generally equal to the equilibrium vapor pressure sustainable by the pressure vessel reactor 10, specifically wall 11, 12, 13, 14 temperature, controller 104 directs that power is removed from flash heater 75. At this point, the internal temperature and pressure of the pressure vessel 10 are in equilibrium. Further decomposition or recombination of the transport material is limited. Therefore, 2NH3+CO2 formed after decomposition remains in quantity within buffer space 82, with heat from heaters 42, 43, 46 and 47 maintaining the transport material and generally preventing significant recombination of the products. As shown in FIG. 9, the decomposition rate of block 81 to transport material is generally linear with respect to power output, and shows a decomposition efficiency in excess of 90%.

At such time as NH3 injection into SCR 103 is required, the normally closed solenoid valve 61 is opened, allowing stored NH3 and CO2 to enter plenum chamber 67 and mix with exhaust gas which has been diverted by an exhaust loop 105, having an inlet portion 106 and an outlet portion 107, from exhaust stream 101. The NH3 and CO2 mix with the exhaust stream in manifold 63 and continue to mix in outlet portion 107 and exhaust stream 101. A corresponding reduction in the internal pressure within pressure vessel reactor 10 occurs. This triggers controller 104 to immediately apply sufficient power to flash heater 75 to maintain internal pressure at between about 5 psi to about 40 psi.

As shown in FIG. 10, until decomposition reaches a steady state, shown at node 110, supply of NH3 to exhaust stream 101 will be insufficient. Thus the exhaust system 100, shown in FIG. 7, can rely on a stored supply of NH3 within buffer space 82 of pressure vessel 10. The maintenance of both temperature and pressure within pressure vessel reactor 10 prevents recombination of the transport material back to ammonium carbamate and thus provides an immediate supply of NH3, without a time lag until the steady state condition at node 110. Once the steady state is reached at time past node 110, the transport material can be injected into the exhaust stream at the same rate that block 81 is decomposing. In addition, the rectangular configuration of pressure vessel reactor 10 assures that buffer space 82 is maximized for a given volume required to house pressure vessel 10 within exhaust system 100 of vehicle.

The invention allows flash heating of ammonium carbonate in which the reactor 10 is held at a sufficient working temperature to prevent significant recombination. As such, the two stage process contemplates decomposing block 81, regulating pressure and sustaining temperature to provide an immediate source of NH3 for exhaust system 100 while achieving a decomposition efficiency of solid ammonium that has a higher density than liquid urea and weighs less.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description.

Having thus described the invention, it is claimed:

1. An ammonia producing device for an exhaust system of an engine comprising:
a pressure vessel including a cavity for storage of pressurized gases, the pressure vessel including insulation located at least partially about the cavity for limiting heat transfer from within the cavity;
a flash heater disposed within the cavity and adjacent a solid ammonia gas producing material; and
an outlet port extending from the pressure vessel and having a valve located therein for providing egress of pressurized gases from within the pressure vessel.

2. The device of claim 1, further comprising a reactor heater for heating contents within the cavity, the reactor heater being disposed about the cavity of the pressure vessel.

3. The device of claim 1, wherein the solid ammonia gas producing material comprises at least one of an ammonium carbamate or an ammonium carbonate.

4. The device of claim 1, wherein the valve comprises a solenoid valve.

5. The device of claim 1, further comprising a temperature sensor for monitoring a temperature of the pressurized gas within the pressure vessel.

6. The device of claim 1, further comprising a pressure sensor for monitoring pressure within the pressure vessel.

7. The device of claim 1, wherein said insulation includes at least on insulation layer disposed within the cavity between said flash heater and an inside wall of the cavity.

8. The device of claim 1, wherein a manifold is connected to the outlet port.

9. The device of claim 8, wherein the manifold has inlet exhaust port and an outlet exhaust port.

10. An exhaust system of an engine comprising:
a pressure vessel including a flash heater and a solid ammonia gas producing material disposed therein, the solid ammonia gas producing material being in contact with the flash heater for generation of heat suitable for decomposition of the solid ammonia gas producing material;
a manifold having an ammonia gas inlet in fluid communication with the pressure vessel and having an exhaust gas inlet and an exhaust gas outlet in fluid communication with a main exhaust supply line;
a control valve regulating flow of ammonia gas between the pressure vessel and the manifold;
a controller in communication with the flash heater and the control valve, the controller causing actuation of the flash heater upon a pressure drop signal from within the pressure vessel and causing opening of the control valve to allow stored ammonia gas to enter the manifold and the exhaust gas stream.

11. The system of claim 10, wherein the solid ammonia gas producing material comprises ammonium carbamate or ammonium carbonate.

12. The system of claim 10, wherein the pressure vessel further comprises at least one layer of insulation within a cavity of the pressure vessel.

13. The system of claim 10, wherein the flash heater generates temperatures of at least about 100° C.

14. The system of claim 10, wherein the pressure vessel further includes a reactor heater for heating contents within the pressure vessel.

15. The system of claim 10, wherein the controller is in further communication with a temperatures sensor that monitors temperature within the pressure vessel and a pressure sensor configured to monitor pressure within the pressure vessel.

16. A method of generating ammonia gas for use by a selective catalytic reduction device comprising:
fluidly coupling a cavity of a pressure vessel to an exhaust gas stream of an engine;
providing a flash heater and a solid ammonia gas producing material within the cavity of the pressure vessel;
heating the flash heater to a temperature suitable for causing decomposition of the solid ammonia gas producing material;
generating an ammonia gas;
storing the ammonia gas with the pressure vessel between successive heating cycles of the flash heater;
providing ammonia gas to the exhaust gas stream.

17. The method of claim 16, including controlling the provision of ammonia gas to the exhaust stream through a control valve.

18. The method of claim 16, wherein the solid ammonia gas producing material comprises ammonium carbamate or ammonium carbonate.

19. The method of claim 16, including heating the flash heater to a temperature of at least about 100° C.
